(19) United States
(12) Patent Application Publication
(10) Pub. No.: US 2026/0310874 A1
(43) Pub. Date: Oct. 8, 2026

(54) REDUCING POWER CONSUMPTION IN A LOGIC CIRCUIT AND RELATED METHODS

(71) Applicant: Microsoft Technology Licensing, LLC, Redmond, WA (US)

(72) Inventors: Harikrishnan KUMARAPILLAI CHANDRIKAKUTTY, Santa Clara, CA (US); Matthew N. PUMAR, Sunnyvale, CA (US); Nicolas MELLIS, Mountain View, CA (US)

(21) Appl. No.: 19/172,605

(22) Filed: Apr. 7, 2025

(51) Int. Cl. G06F 30/398

(52) U.S. Cl. CPC G06F 30/398

(57) ABSTRACT

An exemplary method of inserting clock gate circuits in a logic circuit design includes grouping storage circuits in the logic circuit design into a first plurality of groups and also grouping the storage circuits into a second plurality of groups, where the second plurality of groups has fewer groups than the first plurality of groups. The method includes inserting clock gate circuits into the logic circuit design based on the first plurality of groups to generate a first updated circuit design and based on the second plurality of groups to generate a second updated circuit design. The method also includes selecting one of the first updated circuit design and the second updated circuit design based on a comparison of test results of the first updated circuit design and the second updated circuit design. The storage circuits may be grouped based on storage circuits that toggle in a sequence.

### FIELD OF THE DISCLOSURE

The technology of the disclosure relates, in general, to reducing power consumption in an integrated circuit (IC), and more particularly to automating the design a low-power IC.

### BACKGROUND

Integrated circuits (ICs) are ubiquitous in electronic devices and can be a significant consumer of the power provided to an electronic device. Reducing power consumption in such devices is an objective of manufacturers of ICs, for energy conservation and, in particular, to increase the battery life of hand-held and other battery-powered devices. ICs include semiconductor chips on which transistor circuits are formed. Transistor circuits include sequential logic circuits (e.g., storage circuits) that are able to retain one of two electrical states during the period of a periodic clock signal. Other inputs to the storage circuit determine whether or not the storage circuit actually changes state at the start of a new clock signal period. Switching storage circuits from one state to another can cause electrical nodes in the circuits to be charged and/or discharged, which consumes power. Power may also be consumed in a storage circuit in every cycle of the clock signal even when there is no change of state. As semiconductor chips become more complex and higher performance is demanded, the clock signal frequency increases, further increasing the rate of power consumption.

Even though semiconductor chips in electronic devices are in packages that may have excellent heat dissipation characteristics, the packaging alone may not be enough to handle the problem of excessive heating. This issue may also be addressed in the design and manufacture of the semiconductor chips, by imposing power limits to keep their heat generation lower. Chip designs are subject to power limits that are more and more difficult to achieve as performance requirements increase (e.g., clock frequencies increase). One technique that designers use to reduce power consumption in silicon chips is to include clock gating logic which will gate (i.e., selectively couple) the clock signal provided to a storage circuit depending on whether other input signals provided to the storage circuit indicate that the state of the storage circuit will not change in response to the clock in a particular clock cycle. The clock gating logic may be inserted into a circuit design after a logic design is synthesized into an actual circuit design. When synthesis is completed, power analysis tools may determine that the circuit design exceeds power consumption limits. A designer addresses this by manually figuring out the condition in which a storage circuit will switch states and adding specific clock gating logic to block the clock signal from the storage circuit unless this condition arises. However, there are drawbacks to this method that include increased circuit area and power consumption due to the addition of the clock gating logic, as well as timing problems due to clock gating logic inserted into the clock signal path.

### SUMMARY

Exemplary aspects disclosed herein include reducing power consumption in a logic circuit. Non-transitory computer readable storage medium storing instructions to reduce power consumption in a logic circuit is also disclosed. Reducing power consumption in a logic circuit design may include inserting clock gate circuits into the logic circuit design to selectively couple clock signals that are provided to sequential logic circuits (e.g., storage circuits). A storage circuit may be triggered (e.g., edge triggered or level triggered) by a clock signal and may consume power every time it is triggered by a clock signal. Clock gating is added to block the clock signal from triggering a storage circuit in conditions in which the storage circuit would not change state in response to being triggered by the clock signal.

An exemplary method of inserting clock gate circuits in a logic circuit design includes grouping (e.g., identifying groups of) storage circuits in the logic circuit design into a first plurality of groups and also grouping the storage circuits into a second plurality of groups, where the second plurality of groups has fewer groups than the first plurality of groups. The method includes inserting clock gate circuits into the logic circuit design based on the first plurality of groups to generate a first updated circuit design and based on the second plurality of groups to generate a second updated circuit design. The method also includes selecting one of the first updated circuit design and the second updated circuit design based on a comparison of test results of the first updated circuit design and the second updated circuit design. In some examples, the storage circuits may be grouped into the first plurality of groups based on storage circuits that toggle in a sequence of consecutive clock signal cycles. A logic circuit design may be selected from among multiple updated circuit designs in which storage circuits are clock gated in different groups to provide optimal power consumption.

In one exemplary aspect, a method of reducing power consumption in a logic circuit is disclosed. The method comprises: grouping storage circuits of a logic circuit design into a first plurality of groups, and inserting first clock gate circuits into the logic circuit design to generate a first updated circuit design, wherein each first clock gate circuit is configured to selectively couple a clock signal to the storage circuits in a corresponding group of the first plurality of groups. The method also includes grouping the storage circuits into a second plurality of groups, wherein the second plurality of groups comprises fewer groups than the first plurality of groups, and inserting second clock gate circuits into the logic circuit design to generate a second updated circuit design, wherein each second clock gate circuit is configured to selectively couple the clock signal to the storage circuits in a corresponding group of the second plurality of groups. The method further includes selecting one of the first updated circuit design and the second updated circuit design as a selected design based on a comparison of a first result of a first test executed on the first updated circuit design and a second result of the first test executed on the second updated circuit design.

In another exemplary aspect, a non-transitory computer-readable storage medium is disclosed. The non-transitory computer readable storage medium includes instructions which, when executed by a processor, are configured to control the processor to: group storage circuits of a logic circuit design into a first plurality of groups, and insert first clock gate circuits into the logic circuit design to generate a first updated circuit design, wherein each first clock gate circuit is configured to selectively couple a clock signal to the storage circuits in a corresponding group of the first plurality of groups. The instructions are also configured to control the processor to group the storage circuits into a second plurality of groups, wherein the second plurality of groups comprises fewer groups than the first plurality of groups, and insert second clock gate circuits into the logic circuit design to generate a second updated circuit design, wherein each second clock gate circuit is configured to selectively couple the clock signal to the storage circuits in a corresponding group of the second plurality of groups. The instructions are further configured to control the processor to select one of the first updated circuit design and the second updated circuit design as a selected design based on a comparison of a first result of a first test executed on the first updated circuit design and a second result of the first test executed on the second updated circuit design.

### BRIEF DESCRIPTION OF THE DRAWING FIGURES

The accompanying drawing figures incorporated in and forming a part of this specification illustrate several aspects of the disclosure and, together with the description, serve to explain the principles of the disclosure.

FIG. 1 is a schematic representation of a logic circuit design including combinational and sequential logic circuits (e.g., storage circuits) without clock gate circuits to selectively couple clock signals to the storage circuits;

FIG. 2 is a schematic representation of the combinational logic circuits and storage circuits in the logic circuit design of FIG. 1 including individual clock gate circuits for each storage circuit to selectively couple clock signals to reduce power consumption;

FIG. 3 is a timing diagram illustrating activity in the storage circuits in the logic circuit design in FIG. 1 through multiple cycles of a clock signal provided to the storage circuits during a functional test;

FIGS. 4-7 are schematic representations of circuit designs that include the combinational logic circuits and storage circuits in the logic circuit design in FIG. 1 and are updated to include clock gate circuits based on different groupings of the storage circuits;

FIG. 8 is a flowchart of a method of reducing power consumption in a logic circuit design as shown in FIG. 1, including grouping the storage circuits into first groups and second groups, generating updated versions of the logic circuit design with clock gate circuits inserted for each group, and selecting among the updated circuit designs based on test results;

FIG. 9 is a block diagram of an exemplary processor-based system that may be based on an updated circuit design in which power consumption is reduced by inserting clock gate circuits for a selected plurality of groups of the storage circuits.

### DETAILED DESCRIPTION

With reference to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Exemplary aspects disclosed herein include reducing power consumption in a logic circuit. Non-transitory computer readable storage medium storing instructions to reduce power consumption in a logic circuit is also disclosed. Reducing power consumption in a logic circuit design may include inserting clock gate circuits into the logic circuit design to selectively couple clock signals that are provided to sequential logic circuits (e.g., storage circuits). A storage circuit may be triggered (e.g., edge triggered or level triggered) by a clock signal and may consume power every time it is triggered by a clock signal. Clock gating is added to block the clock signal from triggering a storage circuit in conditions in which the storage circuit would not change state in response to being triggered by the clock signal.

An exemplary method of inserting clock gate circuits in a logic circuit design includes grouping (e.g., identifying groups of) storage circuits in the logic circuit design into a first plurality of groups and also grouping the storage circuits into a second plurality of groups, where the second plurality of groups has fewer groups than the first plurality of groups. The method includes inserting clock gate circuits into the logic circuit design based on the first plurality of groups to generate a first updated circuit design and based on the second plurality of groups to generate a second updated circuit design. The method also includes selecting one of the first updated circuit design and the second updated circuit design based on a comparison of test results of the first updated circuit design and the second updated circuit design. In some examples, the storage circuits may be grouped into the first plurality of groups based on storage circuits that toggle in a sequence of consecutive clock signal cycles. A logic circuit design may be selected from among multiple updated circuit designs in which storage circuits are clock gated in different groups to provide optimal power consumption.

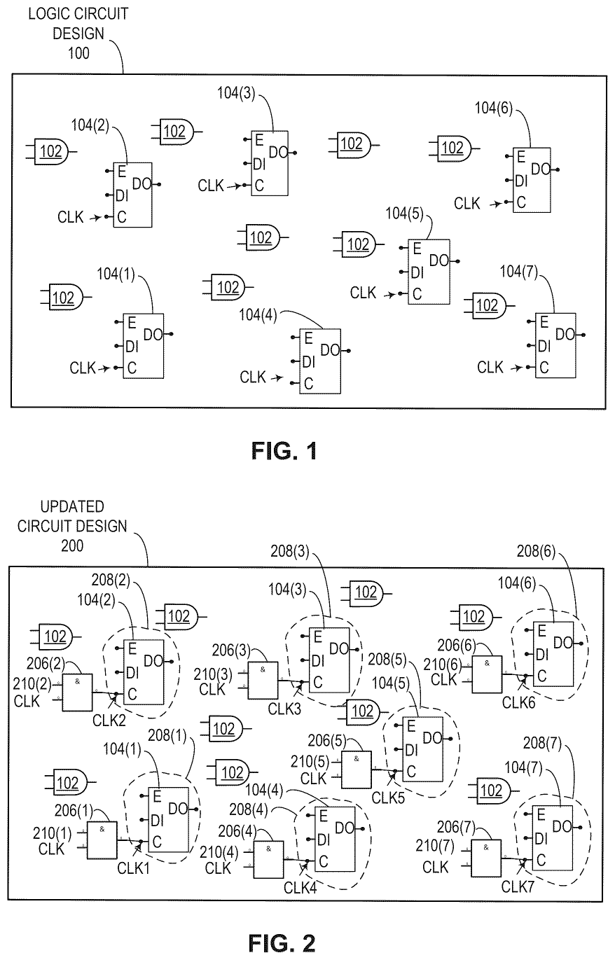

FIG. 1 is a schematic representation of a logic circuit design 100 including combinational logic circuits 102 and sequential logic circuits (e.g., storage circuits) 104(1)-104(N) (where N=7 in this example) without clock gate circuits to selectively couple a clock signal CLK to the storage circuits 104(1)-104(7). The logic circuit design 100 is intended to represent any logic circuit design including any number N of sequential logic circuits, such as storage circuits 104(1)-104(7), to which the methods disclosed herein may be applicable independent of a particular functionality. For this reason, and to avoid unnecessary complexity, FIGS. 1, 2, and 4-7 do not include features such as signal inputs, outputs, and interconnects between the combinational logic circuits 102 and/or the storage circuits 104(1)-104(7).

Signals driven by (e.g., outputs of) the combinational logic circuits 102 may change state, following a brief propagation delay through the combinational logic therein, in response to a change to the state(s) of one or more signals (e.g., inputs) provided to the combinational logic circuits, independent of the clock signal CLK. In contrast, signals driven by the storage circuits 104(1)-104(7) preserve a previously attained state and remain unchanged and independent of the states of signals provided to a data input DI and an enable input E until and in response to being triggered (e.g., “clocked”) by a clock signal CLK received at a clock input C. In some examples, the storage circuits 104(1)-104(7) may be triggered by a transition (e.g., “rising edge” or “falling edge”) of the clock signal CLK or by a level (e.g., voltage) of the clock signal CLK.

In the storage circuits 104(1)-104(7) shown in FIG. 1, a data output DO is driven to a same state as that of a data signal provided to the data input DI if an enable signal provided to the enable input E is in an active (e.g., enabling) state when the storage circuit is triggered by the clock signal CLK. In circumstances in which the storage circuits 104(1)-104(7) are triggered by the clock signal CLK but the enable input E is not in an active state, the data output DO would not change. However, whether or not the data output DO changes state in response to the clock signal CLK, the storage circuits 104(1)-104(7) may consume power each time the storage circuits 104(1)-104(7) are triggered by the clock signal CLK. In alternative examples of the logic circuit design 100, the storage circuits 104(1)-104(7) may exclude the enable input E, in which case a state of the data output DO is driven to a same state as the data input DI when (e.g., in response to) the storage circuits 104(1)-104(7) are triggered by the clock signal CLK. In such examples, when a state of the data input DI is the same as a state of the data output DO of one of the storage circuits 104(1)-104(7), power may still be consumed even though there is no change of state.

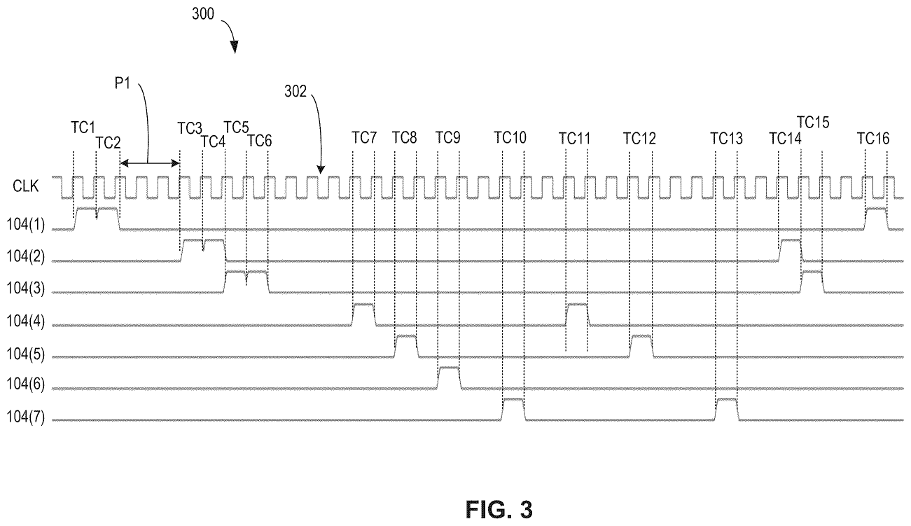

FIG. 2 is a schematic representation of an updated circuit design 200 including the combinational logic circuits 102 and the storage circuits 104(1)-104(N), where N=7 but may be any integer number of storage circuits. The updated circuit design 200 corresponds to the logic circuit design 100 in FIG. 1 and further includes individual clock gate circuits 206(1)-206(N) (where N=7 in this example) for each of groups 208(1)-208(N) (where N=7 in this example) of the storage circuits 104(1)-104(7). The clock gate circuits 206(1)-206(7) are provided to selectively couple (or block) the clock signal CLK to reduce power consumption. The clock gate circuits 206(1)-206(7) may be configured to allow the clock signal CLK to be received at the corresponding storage circuits 104(1)-104(7) under conditions in which a state of the data output DO is going to change. These conditions may be indicated by clock enable signals 210(1)-210(7). The clock enable signals 210(1)-210(7) may be generated based on a combination of signals provided to the enable inputs E and the data inputs DI of a corresponding one of the storage circuits 104(1)-104(7). In response to the clock enable signals 210(1)-210(7), the clock gate circuits 206(1)-206(7) may generate gated clock signals CLK1-CLK7 to trigger the storage circuits 104(1)-104(7), respectively.

In some examples, the clock gate circuits 206(1)-206(7) may be configured to prevent the clock signal CLK from being received at the corresponding storage circuits 104(1)-104(7) under some, most, or all conditions in which the state of the data output DO would not change. Thus, including the clock gate circuits 206(1)-206(7) allows functionality of the updated circuit design 200 to remain unchanged while preventing the storage circuits 104(1)-104(7) from being triggered unnecessarily and, thereby, preventing the storage circuits 104(1)-104(7) from consuming power when there is no change of state to the data output DO. In this manner, total power consumption of an integrated circuit (IC) that includes the updated circuit design 200 in FIG. 2 may be significantly reduced in comparison to an IC that includes the logic circuit design 100 in FIG. 1. In some examples, the updated circuit design 200 may be part of a larger logic circuit design on an IC.

Providing one of the clock gate circuits 206(1)-206(7) for each of the storage circuits 104(1)-104(7) may provide the greatest reduction in power consumption. However, inserting one of the clock gate circuits 206(1)-206(7) for each of the storage circuits 104(1)-104(7) may also have negative consequences, which may include degradation in signal timing in the updated circuit design 200 and/or increased circuit area of the updated circuit design 200. For example, degraded signal timing caused by the clock gate circuits 206(1)-206(7) may include an increase of propagation delays of signals to the data input DI, enable input E (if any), and the clock signal CLK, whether from another one of the storage circuits 104(1)-104(7) or from outside the updated circuit design 200. Another cause for degraded signal timing is increased delays of the clock signal CLK, which can decrease synchronization of the storage circuits 104(1)-104(7), reducing the time available for signals to propagate from one storage circuit to another. Increased circuit area can cause the size of an IC to be larger, which increases cost and may increase the size of an IC package. In still another aspect, incorrectly inserting the clock gate circuits 206(1)-206(7) may cause a reduction in functional quality due to functional errors in the updated circuit design 200. Thus, a method of reducing power consumption in a logic circuit design, while ensuring that functionality is not reduced, that timing requirements are satisfied, and that circuit area is not significantly increased, is needed.

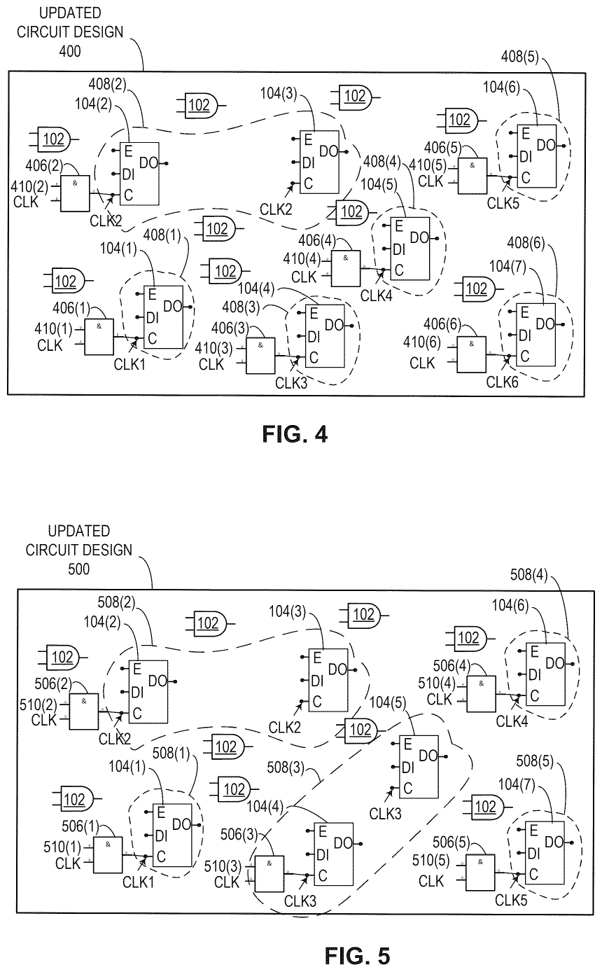

FIG. 3 is a timing diagram 300 illustrating toggling activity in the storage circuits 104(1)-104(7) in the logic circuit design 100 in FIG. 1 over multiple cycles 302 of the clock signal CLK provided to the storage circuits 104(1)-104(7) during a functional test. The expression “toggle”, “toggling,” “toggling event”, or “toggling activity” in this context refers to changes of the state(s) of the data output DO of at least one bit of a storage circuit, such as the storage circuits 104(1)-104(7). In particular, the storage circuits 104(1)-104(7) are digital logic circuits configured to store information in binary form, indicating a logical “0” or a logical “1.” Binary states may also be referred to as “low” and “high”, and may be represented by voltage levels maintained on the data outputs DO during periods of the clock signal CLK. For example, a logical “0” or “low” state may be represented by a low voltage (e.g., 0 volts) and a logical “1” or “high” state may be represented by a high voltage (e.g., 1.5 volts). In some examples, a logical “0” or “low” state may be represented by a high voltage and a logical “1” or “high” state may be represented by a low voltage. Additionally, each of the storage circuits 104(1)-104(7) may store multiple (e.g., from 1 to 64 or more, for example) binary digits (“bits”) representing control signals and/or data. Toggling one of the storage circuits 104(1)-104(7) that stores more than one bit of binary data refers to a cycle or occurrence of a change of at least one bit of such data. A toggling event is not limited to changes of the states of all bits or any particular number of bits, in excess of one bit, in a storage circuit.

The logic states of the storage circuits 104(1)-104(7) shown in the timing diagram 300 may be generated during a simulation of the logic circuit design 100 to represent expected operation of a logic circuit based on the logic circuit design 100 and inputs provided thereto. As shown in FIG. 3, the simulation causes the storage circuit 104(1) to toggle in a first toggle cycle TC1 and a second toggle cycle TC2 of the clock signal CLK. None of the storage circuits 104(1)-104(7) toggle during an inactive period P1 between the second toggle cycle TC2 and a third toggle cycle TC3. In toggle cycles TC3 and TC4, the storage circuit 104(2) toggles, immediately followed in toggle cycles TC5 and TC6 by toggling of the storage circuit 104(3). Due to the inactive period P1 between toggling of the storage circuit 104(1) and the storage circuit 104(2), it may be inferred that there is no relationship or dependency between the toggling of storage circuit 104(1) in toggle cycles TC1 and TC2 and the toggling of the storage circuits 104(2) and 104(3) in toggle cycles TC3-TC6. However, because the storage circuit 104(3) toggles in toggle cycles TC5 and TC6 immediately following the toggling of storage circuit 104(2) in toggle cycles TC3 and TC4, it may be inferred that there is a relationship or dependency between toggling of the storage circuit 104(2) and toggling of the storage circuit 104(3).

Based on the above, it may be inferred that there is no relationship between toggling of the storage circuits 104(4)-104(7) in toggle cycles TC7, TC8, TC9, and TC10, which are separated from each other by at least one cycle of the clock signal CLK. Also, toggling of storage circuits 104(4), 104(5), and 104(7) in toggle cycles TC11, TC12, and TC13, which are also separated from each other by at least one cycle of the clock signal CLK, may not indicate a relationship between such storage circuits. Based on toggle cycles TC14 and TC15, there is again an indication that toggling of the storage circuit 104(3) is dependent on the toggling of storage circuit 104(2), and toggle cycle TC16 does not indicate any toggling relationships or dependencies associated with storage circuit 104(1).

Thus, grouping of the storage circuits of the logic circuit design 100 into a first plurality of groups may include monitoring the storage circuits 104(1)-104(7) in a first test of the logic circuit design 100, identifying sequences of one or more consecutive cycles (e.g., of the clock signal CLK) during the first test in which at least one of the storage circuits 104(1)-104(7) toggles, and, for each sequence identified (such as TC3-TC6 and TC14-TC15), grouping the at least one of the storage circuits 104(1)-104(7) that toggled during the sequence into a first group among a plurality of groups that may be employed in an updated circuit design.

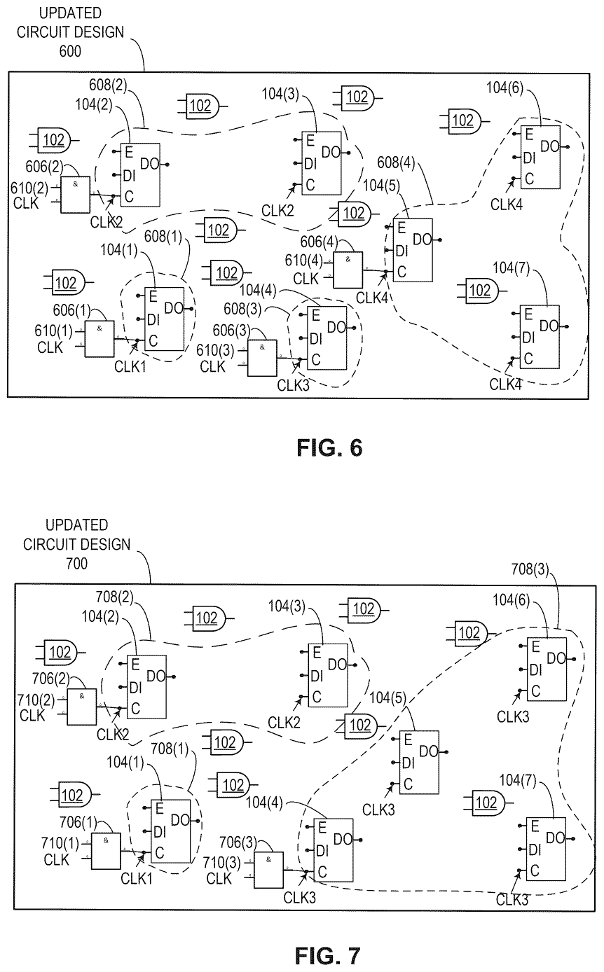

The inferred relationships or dependencies described above are based on sequences of toggling events in consecutive cycles of the clock signal. It should be noted, however, that these are merely inferences and may be shown to be incorrect. The timing diagram 300 is provided for reference to facilitate a description of a method for reducing power consumption in a logic circuit design, which also refers to FIGS. 4-7.

FIGS. 4-7 are schematic representations of updated circuit designs 400-700 that include the combinational logic circuits 102 and the storage circuits 104(1)-104(7) in the logic circuit design 100 in FIG. 1, and the updated circuit designs 400-700 are each updated to include clock gate circuits that gate the clock signal CLK to different groupings of the storage circuits 104(1)-104(7).

FIG. 4 is a schematic representation of a first updated circuit design 400 including clock gate circuits 406(1)-406(6). In contrast to the updated circuit design 200 in FIG. 2, which includes one of the clock gate circuits 206(1)-206(7) for each of the storage circuits 104(1)-104(7), the first updated circuit design 400 includes clock gate circuits 406(1)-406(6) for each of groups 408(1)-408(6). The clock gate circuit 406(2) selective couples (gates) the clock signal CLK to the group 408(2), which includes the storage circuits 104(2) and 104(3). The storage circuits 104(2) and 104(3) are grouped in the group 408(2) based on the relationship between the storage circuit 104(2) and the storage circuit 104(3) that is inferred by the sequence of toggling events in consecutive cycles TC3-TC6 in FIG. 3. The other storage circuits 104(1) and 104(4)-104(7) do not appear to have such relationships with each other or with the storage circuits 104(2) and 104(3) because there are no other sequences of toggle cycles occurring in consecutive cycles of the clock signal CLK in FIG. 3. Accordingly, each of the storage circuits 104(1) and 104(4)-104(7) are grouped into their own respective groups 408(1) and 408(3)-408(6), each comprising a single storage circuit, and the storage circuits in these groups are gated by corresponding clock gate circuits 406(1) and 406(3)-406(6).

Each of the clock gate circuits 406(1)-406(6) receives the clock signal CLK. The clock gate circuit 406(2) couples the clock signal CLK to each of the storage circuits 104(2) and 104(3) as a gated clock signal CLK2 in response to a clock enable signal 410(2). The clock enable signal 410(2) may be activated by the clock gate circuit 406(2) in conditions in which either the storage circuit 104(2) or the storage circuit 104(3) would toggle (e.g., change state) in response to the clock signal CLK. In cycles in which neither of the storage circuits 104(2) and 104(3) would have toggled in response to the clock signal CLK, power consumption can be reduced by blocking the clock signal CLK to the storage circuits 104(2) and 104(3) using the clock gate circuit 406(2). The clock gate circuit 406(1) couples the clock signal CLK to the storage circuit 104(1) as the gated clock signal CLK1. The clock gate circuits 406(3)-406(6) provide the clock signal CLK to the storage circuits 104(4)-104(7) as the gated clock signals CLK3-CLK6, respectively.

Since the storage circuits 104(2) and 104(3) toggle in the sequence of toggle cycles TC3-TC6 in FIG. 3, the clock gate circuit 406(2) may be enabled (e.g., to allow the clock signal CLK to propagate through the clock gate circuit 406(2)) to generate the gated clock signal CLK2 starting in the first toggle cycle TC3 and continuing through the last toggle cycle TC6 before being disabled. That is, the clock enable signal 410(2) may be activated based on a condition for toggling the storage circuit 104(2) in the toggle cycle TC3 and may remain active until the condition for enabling the storage circuit 104(3) in toggle cycle TC6. By such method, the storage circuit 104(2) will be triggered by the gated clock signal CLK2 in toggle cycles TC5 and TC6 even though the storage circuit 104(2) is not expected to toggle in toggle cycles TC5 and TC6. Similarly, the storage circuit 104(3) will be triggered by the gated clock signal CLK2 in toggle cycles TC3 and TC4 even though the storage circuit 104(3) may not toggle in those cycles. Thus, grouping the storage circuits 104(2) and 104(3) and providing a common gated clock signal CLK2 in this manner may still lead to unnecessary power consumption, but the grouping allows for a reduction in the number of clock gate circuits. This tradeoff may be considered beneficial to avoid a significant increase in the circuit area of the logic circuit design 100 that may occur when inserting clock gate circuits for each of the storage circuits, as shown in the updated circuit design 200. The benefit of grouping storage circuits to be triggered by the same gated clock signal may be increased, to some extent, by increasing the number of storage circuits in a group. However, as the number of storage circuits in a group increases, the amount of unnecessary power consumption may increase as well, and another method for grouping the storage circuits is needed. Thus, a method of generating and evaluating prospective groups of storage circuits is needed.

FIG. 5 is a schematic representation of a second updated circuit design 500 based on the logic circuit design 100 in FIG. 1. The updated circuit design 500 includes the combinational logic circuits 102 and the storage circuits 104(1)-104(7) and is updated, relative to the logic circuit design 100 in FIG. 1, to include clock gate circuits 506(1)-506(5) based on grouping the storage circuits 104(1)-104(7) in a second plurality of groups. Here the storage circuit 104(1) is in a group 508(1) and the storage circuits 104(2) and 104(3) are in group 508(2). The storage circuit 104(4) is prospectively grouped with the storage circuit 104(5) in a group 508(3) and the storage circuits 104(6) and 104(7) are in individual groups 508(4) and 508(5). An alternative grouping is employed in FIG. 5 compared to the grouping in FIG. 4, to provide the second plurality of groups 508(1)-508(5) having fewer groups than the first plurality of groups 408(1)-408(6). Since there is one of the clock gate circuits 506(1)-506(5) provided for each of the groups 508(1)-508(5), the reduced number of groups compared to FIG. 4 provides a reduction in the number of clock gate circuits while still achieving a reduction in power consumption. The clock gate circuits 506(1)-506(5) generate, when appropriately enabled, gated clock signals CLK1-CLK5, which are distributed to the storage circuits 104(1)-104(7) according to the groups 508(1)-508(5).

As described above in FIG. 4, the storage circuits 104(2) and 104(3) are grouped together in group 408(2) based on consecutive cycles TC3-TC6 in which storage circuit 104(3) toggles in toggle cycle TC5 immediately following toggling in storage circuit 104(2) in toggle cycle TC4, which appears to indicate a dependent relationship. The other storage circuits 104(1) and 104(4)-104(7) do not appear to have such relationships with each other or with the storage circuits 104(2) and 104(3) because there are no other sequences of toggle cycles occurring in consecutive cycles of the clock signal CLK in FIG. 3. Accordingly, any further grouping of the storage circuits 104(1) and 104(4)-104(7), such as the group 508(3), is not based on an inference of a relationship due to back to back toggle cycles and may be developed by any appropriate method.

One method for further grouping the storage circuits 104(1)-104(7) may include an iterative approach with a progressively increasing scope. That is, initially, each group may be prospectively grouped with one additional group, which means that each of the storage circuits 104(1)-104(7) may initially be prospectively grouped with each of the other storage circuits 104(1)-104(7). The groups 508(1)-508(5) may have been determined in this manner.

A prospective updated circuit design may be generated based on each of such prospective groupings, and tests may be executed on each updated circuit design to determine whether the resultant clock gating affects circuit function. To be more specific, since a gated clock signal is provided to the storage circuits in a group during a window of time beginning with conditions in which a first one of the storage circuits toggles and ending with conditions in which a last one of the storage circuits toggles, any intermediate storage circuits in the group (other than the first and last) is limited to being triggered only during one of such windows. If a storage circuit in the group is expected to toggle outside of such window (e.g., not following a toggle of the first one of the storage circuits) during a functional test, that functional test may indicate an error because that intermediate storage circuit would not be triggered. Such failure of a prospective grouping indicates that an updated circuit design based on the prospective grouping has a lower functional quality and may not be acceptable for generating an IC. In view of this, another method of grouping the storage circuits 104(1)-104(7) into a second plurality of groups 508(1)-508(5) may be employed.

In another example, a method may include, for each previously identified group (e.g., of the groups 408(1)-408(6)), determining whether the toggling of the storage circuits 104(1)-104(7) of a second group of the first plurality of groups 408(1)-408(6) is dependent on or independent from the toggling of the storage circuits 104(1)-104(7) of the first group, and grouping the storage circuits 104(1)-104(7) of the first group and the second group into a third group of the second plurality of groups 508(1)-508(5) if the storage circuits 104(1)-104(7) of the second group do not toggle independently from the first group. A clock gate circuit may be inserted into the logic circuit design to provide a gated clock signal to all the storage circuits in the third group. A finite state machine (FSM) may be added to the logic circuit design to generate the gate enable signal, which may be activated for a sequence of cycles of the clock signal CLK that includes the toggling of all the storage circuits in the third group. The FMS may activate the gate enable signal for a clock gate circuit of the third group in a cycle of the clock signal CLK in which there is a condition for a first storage circuit of the third group to toggle in the sequence of cycles, and the FSM may keep the gate enable signal active until a cycle in which the last the storage circuit of the third group toggles in the sequence.

Another consideration in generating a plurality of groups for a circuit design is whether a prospective grouping (plurality of groups) reduces the number of clock gate circuits (e.g., and groups) compared to a previous grouping. Since an objective of regrouping the storage circuits is to reduce a number of the clock gate circuits, a prospective grouping may be rejected if it does not reduce the number of groups.

Based on these two different pluralities of groups, the first updated circuit design 400 and the second updated circuit design 500 may be generated. Generating the updated circuit design 400 includes inserting clock gate circuits 406(1)-406(6) into the logic circuit design 100, where each of the clock gate circuits 406(1)-406(6) is configured to selectively couple the clock signal CLK to the storage circuits 104(1)-104(7) in a corresponding group of the first plurality of groups 408(1)-408(6). Generating the second updated circuit design 500 includes inserting clock gate circuits 506(1)-506(5) into the logic circuit design 100, where each of the clock gate circuits 506(1)-506(5) is configured to selectively couple the clock signal CLK to the storage circuits 104(1)-104(7) in a corresponding group of the second plurality of groups 508(1)-508(5).

One of the updated circuit design 400 and the updated circuit design 500 may be selected as preferable for use in an IC. Selecting one of these updated circuit designs may be based on a comparison of power consumption of a first updated circuit design and a second updated circuit design, such as the updated circuit designs 400 and 500, according to a first result of the first updated circuit design and a second result of the second updated circuit design. That is, a functional test (e.g., regression simulation) is executed in the updated circuit design 400 and also executed in the updated circuit design 500. The test results may be used to gather various information about the respective updated circuit designs 400 and 500. In addition to confirming that both updated circuit designs 400 and 500 are functionally equivalent (or substantially equivalent) to the logic circuit design 100, the test results may also provide information regarding power consumption and signal timing (e.g., propagation delay). In another aspect, updated physical design information may be generated from the updated circuit designs 400 and 500 and compared to the original logic circuit design 100 to determine respective increases in circuit area of the updated circuit designs 400 and 500 compared to the logic circuit design 100. As an example, a difference (Delta) between the updated circuit design 400 and the original logic circuit design 100 may be calculated by the following:

$$Delta = α ( Function 400 - Function 100 ) + β ( Power 400 - Power 100 ) + γ ( Timing 400 - Timing 100 ) + δ ( Area 400 - Area 100 ) ,$$

where:

α, β, γ, and δ are weights for Function, Power, Timing, and Area, respectively;

Function400 and Function100 indicate function quality;

Power400 and Power100 indicate power consumption;

Timing400 and Timing100 indicate timing quality; and

Area400 and Area100 indicate circuit area.

In some examples, other characteristics (other than Function, Power, Timing, and Area) of the respective updated circuit designs 400 and 500 may be compared to the original logic circuit design 100, or compared to each other, as a basis for selecting one updated circuit design as a selected or preferred design. The selected design may provide an improved balance of lower power consumption, performance, and area in an IC that is manufactured based on the selected design. For example, the selected design may be selected based on a weighted comparison of power consumption and functional quality in the test results, where power consumption is indicated by the variables Power400 and Power100 and functional quality is indicated by the variables Function400 and Function100. The selected design may be selected based on a weighted comparison of power consumption and signal timing in the test results, where power consumption is indicated by the variables Power400 and Power100 and signal timing is indicated by the variables Timing400 and Timing100. The selected design may be selected based on a weighted comparison of power consumption and circuit area in the test results, where power consumption is indicated by the variables Power400 and Power100 and circuit area is indicated by the variables Area400 and Area100.

Based on comparisons of the test results, which may include a calculation of the “Delta” shown above, one of the updated circuit designs 400 and 500 may be determined to be preferable and may be selected for use. Alternatively, as shown in FIGS. 6 and 7, additional updated circuit designs 600 and 700 may be generated based on grouping the storage circuits 104(1)-104(7) in a new plurality of groups, each having fewer groups than the plurality of groups in the updated circuit designs 400 and 500. As noted above, each of the storage circuits 104(1)-104(7) may initially be iteratively grouped with one of each of the other storage circuits to create the groups 508(1)-508(5). Such iterative grouping may be performed by any appropriate algorithm that explores (e.g., generates and tests) possible grouping options. After testing options of one-to-one prospective groupings, an iterative approach may be expanded to prospectively group the storage circuits 104(1)-104(7) in larger groups, to reduce the total number of groups. This may lead to combining existing groups. In each iteration, one storage circuit may be prospectively grouped with two storage circuits, followed by prospective grouping with three storage circuits, and so on in increasing numbers of storage circuits, where each grouping is tested for function and may be rejected if it does not lead to a reduction in the total number of groups. This approach may lead to the pluralities of groups illustrated in FIGS. 6 and 7.

FIG. 6 is a schematic representation of another updated circuit design 600 based on the logic circuit design 100 in FIG. 1. The updated circuit design 600 includes the combinational logic circuits 102 and the storage circuits 104(1)-104(7) and is updated to include clock gate circuits 606(1)-606(4) based on a plurality of groups 608(1)-608(4) of the storage circuits 104(1)-104(7). Here the storage circuit 104(1) is in a group 608(1) and the storage circuit 104(4) is in a group 608(3), each including a single storage circuit. As in FIGS. 4 and 5, the storage circuits 104(2) and 104(3) are grouped together due to their inferred relationship in group 608(2). However, in contrast to FIG. 5, storage circuit 104(5) is grouped with the storage circuits 104(6) and 104(7) in group 608(4). The plurality of groups employed in FIG. 6 comprises fewer groups than the first plurality of groups 408(1)-408(6) in FIG. 4 and the second plurality of groups 508(1)-508(5) in FIG. 5. Accordingly, the number of clock gate circuits 606(1)-606(4) is reduced while continuing to provide a reduction in power consumption compared to the original logic circuit design 100. The clock gate circuits 606(1)-606(4) generate, when respectively enabled, gated clock signals CLK1-CLK4, which are distributed to the storage circuits 104(1)-104(7) according to the groups 608(1)-608(4).

FIG. 7 is a schematic representation of another updated circuit design 700 based on the logic circuit design 100 in FIG. 1. The updated circuit design 700 includes the combinational logic circuits 102 and the storage circuits 104(1)-104(7) and is updated to include clock gate circuits 706(1)-706(3) based on a plurality of groups 708(1)-708(3) of the storage circuits 104(1)-104(7). In this example, the storage circuit 104(1) is in the group 708(1), the storage circuits 104(2) and 104(3) are grouped together in group 708(2), and the remaining storage circuits 104(4)-104(7) are grouped in group 708(3). The clock gate circuits 706(1)-706(3) receive the clock signal CLK and distribute, when respectively enabled, gated clock signals CLK1, CLK2, and CLK3 to the storage circuits 104(1)-104(7) according to the groups 708(1)-708(3). The plurality of groups employed in FIG. 7 comprises fewer clock gate circuits, according to the number of groups, to reduce circuit area compared to the updated circuit designs 400, 500, and 600, while continuing to provide some reduction in power consumption compared to the original logic circuit design 100.

In the updated circuit design 700, the clock gate circuit 706(3) may be inserted into the logic circuit design 100 to provide the gated clock signal CLK3 to all the storage circuits 104(4)-104(7) in the group 708(3). An FSM (not shown) may be added to the updated circuit design 700 to generate a gate enable signal 710(3) to cause the clock gate circuit 706(3) to pass the clock signal CLK to the storage circuits 104(4)-104(7) as the gated clock signal CLK3. The gate enable signal 710(3) may be activated for a sequence of cycles of the clock signal CLK that includes the toggling of all the storage circuits in the third group. The FSM may activate the gate enable signal 710(3) for a clock gate circuit of the third group 708(3) in a cycle of the clock signal CLK in which there is a condition for a first storage circuit of the third group to toggle in the sequence of cycles, and the FSM may keep the gate enable signal 710(3) active until a cycle in which the last storage circuit of the third group 708(3) toggles in the sequence.

For example, referring again to FIG. 3, an FSM may activate the gate enable signal 710(3) in the toggle cycle TC7 and keep the gate enable signal 710(3) active until the toggle cycle TC10. Then the FSM may activate the gate enable signal 710(3) again in the toggle cycle TC11 and keep the gate enable signal 710(3) active until the toggle cycle TC13.

Although the reduced number of groups and, therefore, clock gate circuits reduces the circuit area of the updated circuit designs 400-700 compared to the updated circuit design 200 in FIG. 2, the reduction in the number of groups may lead to inefficiencies in the reduction in power consumption. For example, with additional reference to FIG. 3, between toggle cycles TC8 and TC10, the storage circuit 104(6) toggles in toggle cycle TC9. Thus, sharing a clock gate circuit 706(3) among the storage circuits 104(4)-104(7) reduces the circuit area and allows each of the storage circuits 104(4)-104(7) to be triggered in a window of time from toggle cycle TC7 to TC10 but not to be triggered outside this window. However, between toggle cycles TC12 and TC13, in which storage circuits 104(5) and 104(7) toggle again, the storage circuit 104(6) does not toggle. Therefore, providing the gated clock signal CLK3 to trigger the storage circuit 104(6) during the window from the toggle cycle TC11 to toggle cycle TC13 causes the storage circuit 104(6) to be unnecessarily triggered and consume power. Accordingly, as shown in the calculation of Delta, above, the selection of an updated circuit design is based on a balance of characteristics that may be affected by grouping the storage circuits and providing clock gate circuits for each group.

As illustrated in FIGS. 6 and 7, a method of reducing the power consumption in the logic circuit design 100 may include grouping the storage circuits 104(1)-104(7) of the logic circuit design 100 into a third plurality of groups 608(1)-608(4), wherein the third plurality of groups 608(1)-608(4) comprises fewer groups than the second plurality of groups 508(1)-508(5), comprising, for each third group of the second plurality of groups 508(1)-508(5), determining that the toggling of the storage circuits of a fourth group of the second plurality of groups 508(1)-508(5) is dependent on toggling of the storage circuits of the third group; and grouping the storage circuits of the third group and the fourth group into a fifth group of the third plurality of groups 608(1)-608(4). The method of reducing the power consumption further includes generating a third updated circuit design 600 comprising third clock gate circuits 606(1)-606(4) inserted into the logic circuit design 100, wherein each third clock gate circuit 606(1)-606(4) is configured to selectively couple the clock signal to the storage circuits 104(1)-104(7) in a group of the third plurality of groups 608(1)-608(4). Selecting an updated circuit design may include selecting one of a first updated circuit design 400, a second updated circuit design 500, and a third updated circuit design 600 as a selected circuit design based on a comparison of a first result of a first test executed on the first updated circuit design 400, a second result of the first test executed on the second updated circuit design 500, and a third result of the first test executed on the third updated circuit design 600.

It should be understood that the methods described herein are not limited to a particular logic circuit design or to the specific groups, number of groups or group sizes described herein. In an actual logic circuit design updated according to the discussion herein, there may be tens, hundreds, or thousands of storage circuits in a logic circuit design or in any of the groups in a plurality of groups. In addition, there may be any appropriate number of groups in a logic circuit design. Furthermore, a logic circuit design may include fewer or more combinational logic circuits and/or storage circuits than the logic circuit design 100. The term “storage circuits” as used herein refers to sequential logic circuits, which may include registers, flip-flops, latches, etc. that may contain any integer number of “bits” of digital information. A sequential logic circuit may include circuits that maintain a voltage level on an output after being triggered by a clock signal in a first cycle of the clock signal until being triggered again by the clock signal in a next cycle of the clock signal, independent of changes to the states of other inputs to the sequential logic circuit.

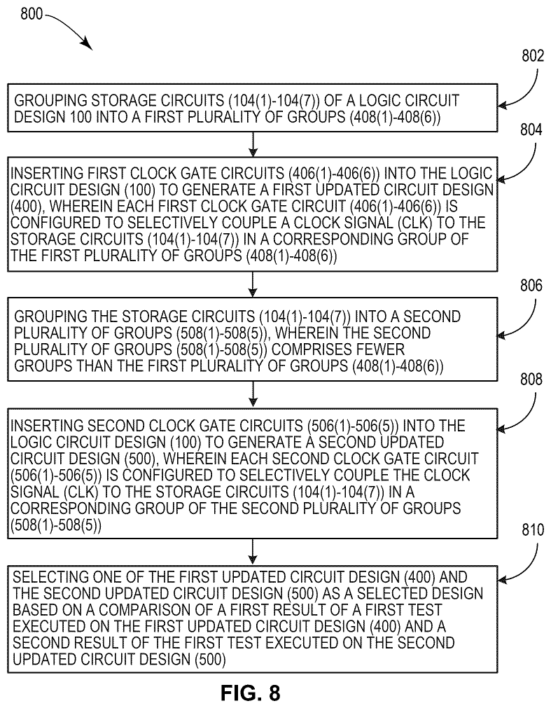

FIG. 8 is a flowchart of a method 800 of reducing power consumption in a logic circuit design. The method 800 includes grouping storage circuits 104(1)-104(7) of a logic circuit design 100 into a first plurality of groups 408(1)-408(6) (block 802) and inserting first clock gate circuits 406(1)-406(6) into the logic circuit design 100 to generate a first updated circuit design 400, wherein each first clock gate circuit (406(1)-406(6)) is configured to selectively couple a clock signal CLK to the storage circuits 104(1)-104(7) in a corresponding group of the first plurality of groups 408(1)-408(6) (block 804). The method includes grouping the storage circuits 104(1)-104(7) into a second plurality of groups 508(1)-508(5), wherein the second plurality of groups 508(1)-508(5) comprises fewer groups than the first plurality of groups 408(1)-408(6) (block 806) and inserting second clock gate circuits 506(1)-506(5) into the logic circuit design 100 to generate a second updated circuit design 500, wherein each second clock gate circuit 506(1)-506(5) is configured to selectively couple the clock signal CLK to the storage circuits 104(1)-104(7) in a corresponding group of the second plurality of groups 508(1)-508(5) (block 808). The method also includes selecting one of the first updated circuit design 400 and the second updated circuit design 500 as a selected design based on a comparison of a first result of a first test executed on the first updated circuit design 400 and a second result of the first test executed on the second updated circuit design 500 (block 810).

Another method of reducing power consumption in a logic design may include parsing a logic circuit design (e.g., in register transfer language (RTL) format) to identify storage circuits in the logic design, modifying a test interface to monitor state changes of the storage circuits in the logic circuit design during a test, and performing a regression test of the logic circuit design. The method may further include grouping the storage circuits into first groups based on sequences of toggle events and grouping the storage circuits into second groups, which includes combining the first groups. The method further includes inserting clock gate circuits into the logic circuit design for each of the second groups to generate an updated logic circuit design and performing the regression test of the updated logic circuit design. The method also includes comparing results of the regression test of the logic circuit design and the updated logic circuit design to determine a difference (Delta) of the updated logic circuit design.

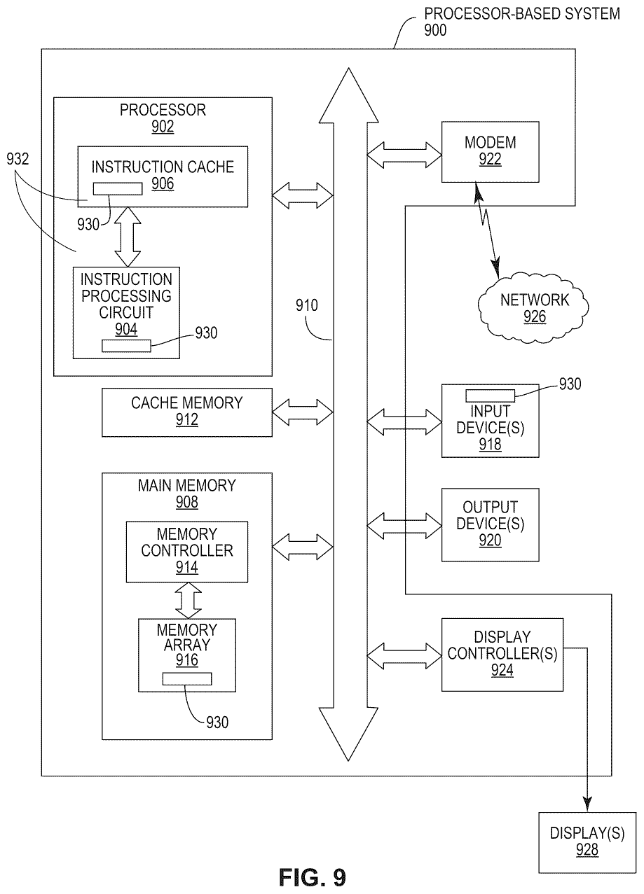

FIG. 9 is a block diagram of an exemplary processor-based system 900 that includes a processor 902 (e.g., a microprocessor), including an instruction processing circuit 904. The processor-based system 900 may include integrated circuits on an electronic board or card, such as a printed circuit board (PCB), in a server, a personal computer, a desktop computer, a laptop computer, a personal digital assistant (PDA), a computing pad, a mobile device, or any other device, and may represent, for example, a server or a user's computer. In this example, the processor-based system 900 includes the processor 902. The processor 902 represents one or more general-purpose processing circuits, such as a microprocessor, central processing unit, or the like. More particularly, the processor 902 may be an EDGE instruction set microprocessor or other processor implementing an instruction set that supports explicit consumer naming for communicating produced values resulting from the execution of producer instructions.

The processor 902 is configured to execute instructions for performing the operations and steps discussed herein. In this example, the processor 902 includes an instruction cache 906 for temporary, fast access memory storage of instructions accessible by the instruction processing circuit 904. Fetched or prefetched instructions from a memory, such as a main memory 908, over a system bus 910, are stored in the instruction cache 906. Data may be stored in a cache memory 912 coupled to the system bus 910 for low-latency access by the processor 902. The instruction processing circuit 904 is configured to process instructions fetched into the instruction cache 906 and process the instructions for execution.

The processor 902 and the main memory 908 are coupled to the system bus 910 and can intercouple peripheral devices included in the processor-based system 900. As is well known, the processor 902 communicates with these other devices by exchanging address, control, and data information over the system bus 910. For example, the processor 902 can communicate bus transaction requests to a memory controller 914 in the main memory 908 as an example of a controlled device. Although not illustrated in FIG. 9, multiple system buses 910 could be provided, wherein each system bus 910 constitutes a different fabric. In this example, the memory controller 914 is configured to provide memory access requests to a memory array 916 in the main memory 908. The memory array 916 is comprised of an array of storage bit cells for storing data. The main memory 908 may be a read-only memory (ROM), flash memory, dynamic random-access memory (DRAM), such as synchronous DRAM (SDRAM), etc. and/or static memory (e.g., flash memory, SRAM, etc.), as non-limiting examples.

Other devices can be connected to the system bus 910. As illustrated in FIG. 9, these devices can include the main memory 908, one or more input device(s) 918, one or more output device(s) 920, a modem 922, and one or more display controllers 924, as examples. The input device(s) 918 can include any type of input device, including but not limited to input keys, switches, voice processors, etc. The output device(s) 920 can include any type of output device, including but not limited to audio, video, other visual indicators, etc. The modem 922 can be any device configured to allow an exchange of data to and from a network 926. The network 926 can be any type of network, including but not limited to a wired network (e.g., ethernet) or wireless network, a private or public network, a local area network (LAN), a wireless local area network (WLAN), a wide area network (WAN), a BLUETOOTH™ network, and the Internet. The modem 922 can be configured to support any type of communications protocol desired. The processor 902 may also be configured to access the display controller(s) 924 over the system bus 910 to control information sent to one or more displays 928. The display(s) 928 can include any type of display, including but not limited to a cathode ray tube (CRT), a liquid crystal display (LCD), a plasma display, etc.

The processor based system 900 may include one or more logic circuit designs based on a selected updated circuit design in which power consumption is reduced according to the methods disclosed herein.

The processor-based system 900 in FIG. 9 may include a set of instructions 930 to be executed by the processor 902 for any application desired according to the instructions. The instructions 930 may be stored in the main memory 908, the processor 902, and/or the instruction cache 906 as examples of a non-transitory computer-readable medium 932. The instructions 930 may also reside, completely or at least partially, within the main memory 908 and/or within the processor 902 during their execution. The instructions 930 may further be transmitted or received over the network 926 via the modem 922, such that the network 926 includes the computer-readable medium 932.

While the computer-readable medium 932 is shown in an exemplary embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the processing device and that causes the processing device to perform any one or more of the methodologies of the embodiments disclosed herein. The term “computer-readable medium” shall accordingly be taken to include, but not be limited to, solid-state memories, optical medium, and magnetic medium.

The embodiments disclosed herein include various steps. The steps of the embodiments disclosed herein may be formed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product or software that may include a machine-readable medium (or a computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes a machine-readable storage medium (e.g., ROM, random access memory (“RAM”), a magnetic disk storage medium, an optical storage medium, flash memory devices, etc.), and the like.

Unless specifically stated otherwise and as apparent from the previous discussion, it is appreciated that throughout the description, discussions utilizing terms such as “processing,” “computing,” “determining,” “displaying,” or the like refer to the action and processes of a computer system, or similar electronic computing device, that manipulates and transforms data and memories represented as physical (electronic) quantities within the computer system's registers into other data similarly represented as physical quantities within the computer system memories or registers or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. In addition, the embodiments described herein are not described with reference to any particular programming language. It will be appreciated that a variety of programming languages may be used to implement the teachings of the embodiments as described herein.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends on the particular application, design choices, and/or design constraints imposed on the overall system. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA), or other programmable logic device, a discrete gate or transistor logic, discrete hardware components, or any combination thereof designed to perform the functions described herein. Furthermore, a controller may be a processor. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The embodiments disclosed herein may be embodied in hardware and in instructions that are stored in hardware and may reside, for example, in RAM, flash memory, ROM, Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from and write information to the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. Those of skill in the art will also understand that information and signals may be represented using any of a variety of technologies and techniques. For example, data, instructions, commands, information, signals, bits, symbols, and chips that may be referenced throughout the above description may be represented by voltages, currents, electromagnetic waves, magnetic fields, optical fields, or particles, or any combination thereof.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modifications, combinations, sub-combinations, and variations of the disclosed embodiments incorporating the spirit and substance of the invention may occur to persons skilled in the art, the invention should be construed to include everything within the scope of the appended claims and their equivalents.

What is claimed is:

1. A method of reducing power consumption in a logic circuit, comprising:
grouping storage circuits of a logic circuit design into a first plurality of groups;
inserting first clock gate circuits into the logic circuit design to generate a first updated circuit design, wherein each first clock gate circuit is configured to selectively couple a clock signal to the storage circuits in a corresponding group of the first plurality of groups;
grouping the storage circuits into a second plurality of groups, wherein the second plurality of groups comprises fewer groups than the first plurality of groups;
inserting second clock gate circuits into the logic circuit design to generate a second updated circuit design, wherein each second clock gate circuit is configured to selectively couple the clock signal to the storage circuits in a corresponding group of the second plurality of groups; and
selecting one of the first updated circuit design and the second updated circuit design as a selected design based on a comparison of a first result of a first test executed on the first updated circuit design and a second result of the first test executed on the second updated circuit design.

2. The method of claim 1, further comprising manufacturing an integrated circuit (IC) based on the selected design.

3. The method of claim 1, further comprising selecting the selected design based on a comparison of power consumption of the first updated circuit design and power consumption of the second updated circuit design according to the first result and the second result.

4. The method of claim 1, wherein grouping the storage circuits of the logic circuit design into the first plurality of groups comprises:
identifying sequences of one or more consecutive cycles during the first test in which at least one of the storage circuits toggles; and
for each sequence identified, grouping the at least one of the storage circuits that toggled during the sequence into a first group of the first plurality of groups.

5. The method of claim 4, wherein grouping the storage circuits of the logic circuit design into the second plurality of groups comprises, for the first group in the first plurality of groups of each sequence identified:
determining that toggling of the storage circuits of a second group of the first plurality of groups is dependent on the toggling of the storage circuits of the first group; and
grouping the storage circuits of the first group and the second group into a third group of the second plurality of groups.

6. The method of claim 5, further comprising:
grouping the storage circuits of the logic circuit design into a third plurality of groups wherein the third plurality of groups comprises fewer groups than the second plurality of groups, comprising, for each third group of the second plurality of groups:
determining that toggling of the storage circuits of a fourth group of the second plurality of groups is dependent on the toggling of the storage circuits of the third group; and
grouping the storage circuits of the third group and the fourth group into a fifth group of the third plurality of groups;
generating a third updated circuit design comprising third clock gate circuits inserted into the logic circuit design, wherein each third clock gate circuit is configured to selectively couple the clock signal to the storage circuits in a group of the third plurality of groups; and
selecting one of the first updated circuit design, the second updated circuit design, and the third updated circuit design as the selected design based on a comparison of the first result of the first test executed on the first updated circuit design, the second result of the first test executed on the second updated circuit design, and a third result of the first test executed on the third updated circuit design.

7. The method of claim 3, further comprising selecting the selected design based on a weighted comparison of power consumption and functional quality of the first updated circuit design according to the first result and power consumption and functional quality of the second updated circuit design according to the second result.

8. The method of claim 3, further comprising selecting the selected design based on a weighted comparison of power consumption and signal timing of the first updated circuit design according to the first result and power consumption and signal timing of the second updated circuit design according to the second result.

9. The method of claim 3, further comprising selecting the selected design based on a weighted comparison of power consumption and circuit area of the first updated circuit design according to the first result and power consumption and circuit area of the second updated circuit design according to the second result.

10. The method of claim 1, further comprising selecting the selected design based on a weighted comparison of power consumption, functional quality, signal timing, and circuit area of the first updated circuit design according to the first result and power consumption, functional quality, signal timing, and circuit area of the second updated circuit design according to the second result.

11. The method of claim 5, wherein one of the second clock gate circuits inserted in the second updated circuit design allows the clock signal to trigger the storage circuits in the third group of the second plurality of groups in response to a first condition that toggles a first storage circuit in the first group of the first plurality of groups and blocks the clock signal from triggering the storage circuits in the third group of the second plurality of groups following a second condition that toggles a second storage circuit in the second group of the first plurality of groups.

12. A non-transitory computer-readable storage medium comprising instructions which, when executed by a processor, are configured to control the processor to:
group storage circuits of a logic circuit design into a first plurality of groups;
insert first clock gate circuits into the logic circuit design to generate a first updated circuit design, wherein each first clock gate circuit is configured to selectively couple a clock signal to the storage circuits in a corresponding group of the first plurality of groups;
group the storage circuits into a second plurality of groups, wherein the second plurality of groups comprises fewer groups than the first plurality of groups;
insert second clock gate circuits into the logic circuit design to generate a second updated circuit design, wherein each second clock gate circuit is configured to selectively couple the clock signal to the storage circuits in a corresponding group of the second plurality of groups; and
select one of the first updated circuit design and the second updated circuit design as a selected design based on a comparison of a first result of a first test executed on the first updated circuit design and a second result of the first test executed on the second updated circuit design.

13. The non-transitory computer-readable storage medium of claim 12, wherein the instructions are further configured to control the processor to select the selected design based on the comparison of the first result and the second result indicating which of the first updated circuit design and the second updated circuit design uses lower power.

14. The non-transitory computer-readable storage medium of claim 12, wherein controlling the processor to group the storage circuits of the logic circuit design to the first plurality of groups further comprises controlling the processor to:
identify sequences of one or more consecutive cycles during the first test in which at least one of the storage circuits toggles; and
for each sequence identified, group the at least one of the storage circuits that toggled during the sequence into a first group of the first plurality of groups.

15. The non-transitory computer-readable storage medium of claim 14, wherein controlling the processor to group the storage circuits of the logic circuit design to the second plurality of groups further comprises controlling the processor to, for the first group in the first plurality of groups of each sequence identified:
determine that the toggling of the storage circuits of a second group of the first plurality of groups is dependent on toggling of the storage circuits of the first group; and
group the storage circuits of the first group and the second group into a third group of the second plurality of groups.

16. The non-transitory computer-readable storage medium of claim 15, further comprising instructions which, when executed by the processor, control the processor to:
group the storage circuits of the logic circuit design to a third plurality of groups wherein the third plurality of groups comprises fewer groups than the second plurality of groups, comprising, for each third group of the second plurality of groups:
determine that the toggling of the storage circuits of a fourth group of the second plurality of groups is dependent on toggling of the storage circuits of the third group; and
group the storage circuits of the third group and the fourth group into a fifth group of the third plurality of groups;
generate a third updated circuit design comprising third clock gate circuits inserted into the logic circuit design, wherein each third clock gate circuit is configured to selectively couple the clock signal to the storage circuits in a group of the third plurality of groups; and
select one of the first updated circuit design, the second updated circuit design, and the third updated circuit design as the selected design based on a comparison of the first result of the first test executed on the first updated circuit design, the second result of the first test executed on the second updated circuit design, and a third result of the first test executed on the third updated circuit design.

17. The non-transitory computer-readable storage medium of claim 12, further comprising instructions configured to control the processor to select the selected design based on a weighted comparison of power consumption and functional quality of the first updated circuit design according to the first result and power consumption and functional quality of the second updated circuit design according to the second result.

18. The non-transitory computer-readable storage medium of claim 12, further comprising instructions configured to control the processor to select the selected design based on a weighted comparison of power consumption and signal timing of the first updated circuit design according to the first result and power consumption and signal timing of the second updated circuit design according to the second result.

19. The non-transitory computer-readable storage medium of claim 12, further comprising instructions configured to control the processor to select the selected design based on a weighted comparison of power consumption and circuit area of the first updated circuit design according to the first result and power consumption and circuit area of the second updated circuit design according to the second result.

20. The non-transitory computer-readable storage medium of claim 12, further comprising instructions configured to control the processor to select the selected design based on a weighted comparison of power consumption, functional quality, signal timing, and circuit area of the first updated circuit design according to the first result and the power consumption, functional quality, signal timing, and circuit area of the second updated circuit design according to the second result.
